(19) United States
(12) Patent Application Publication
(10) Pub. No.: US 2021/0398457 A1
(43) Pub. Date: Dec. 23, 2021

(54) CABLE LINE LABEL DEVICE

(71) Applicant: Jacob Meyers, Meadville, MO (US)

(72) Inventor: Jacob Meyers, Meadville, MO (US)

(21) Appl. No.: 17/351,505

(22) Filed: Jun. 18, 2021

Related U.S. Application Data
(60) Provisional application No. 63/042,489, filed on Jun. 22, 2020.

(51) Int. Cl. G09F 3/00

(52) U.S. Cl. CPC G09F 3/0295

(57) ABSTRACT

A cable line label device includes a platform. The platform has a top end positioned opposite a bottom end. Additionally, the platform also includes a first side formed opposite a second side. The platform defines an arcuate curvature from the first side to the second side. The platform will form a flush surface with a cable when the cable line label device is placed on the cable. A first fastener is placed at a top end of the platform and a second fastener is placed at a bottom end of the platform. The first fastener and the second fastener are designed to secure the platform to the cable.

### CROSS REFERENCE TO RELATED APPLICATIONS

This application claims the benefit of U.S. Provisional Application No. 63/042,489 filed on Jun. 22, 2020. The above identified patent application is herein incorporated by reference in its entirety to provide continuity of disclosure.

### BACKGROUND OF THE INVENTION

The present invention relates to an agricultural line label device. More specifically, the present invention provides a label for cables that is easily affixable to a desired cable that may be utilized to identify the utility of the specific cable.

Hydraulic hoses, pipes and the like can be difficult to identify when working at a construction site, an agricultural site, or a similar location. These hoses and pipes can be placed into the incorrect outlets, causing frustration. Additionally, it can add time-consuming work for the workers to correct the incorrectly placed hoses and pipes. In some cases, incorrectly placed hoses and pipes can create dangerous or harmful situations. Therefore, there is a defined need amongst the known prior art references for a device designed to prevent the incorrect attachment of pipes and hoses.

### SUMMARY OF THE INVENTION

In view of the foregoing disadvantages inherent in the known types of hose and pipe labeling methods and devices now present in the prior art, the present invention provides a cable line label device wherein the same can be utilized for providing convenience for the user when labeling utility cables or the like.

The present system comprises a platform. The platform comprises a top end opposite a bottom end. Additionally, the platform further comprises a first side defined opposite a second side. The platform is defined an arcuate curvature from the first side to the second side. As such, the platform will form a flush surface with a cable when the cable line label device is placed upon the cable. A first fastener is disposed at a top end of the platform. A second fastener is disposed at a bottom end of the platform. The first fastener and the second fastener are configured to secure the platform to the cable.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the cable line label device.

FIG. 2 shows a perspective view of an embodiment of the cable line label device.

FIG. 3 shows a demonstrative view of a plurality of cable line label devices.

### DETAILED DESCRIPTION OF THE INVENTION

Reference is made herein to the attached drawings. Like reference numerals are used throughout the drawings to depict like or similar elements of the cable line label device. The figures are intended for representative purposes only and should not be considered to be limiting in any respect.

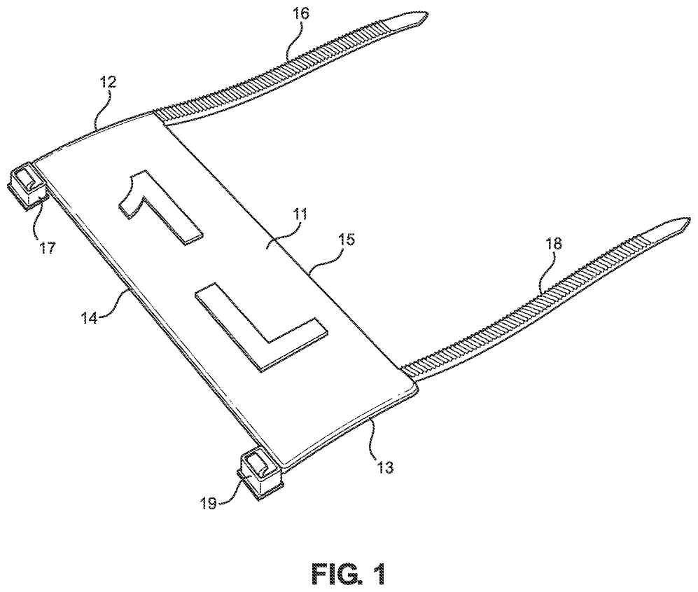

Referring now to FIG. 1, there is shown a perspective view of an embodiment of the cable line label device. The cable line label device 10 comprises a platform 11. The platform comprises a top end 12. The top end 12 is defined opposite a bottom end 13. Furthermore, the platform comprises a first side 14. The first side 14 is defined opposite a second side 15. In the illustrated embodiment, the length of the top end 12 from the first side 14 to the second side 15 is equal to the length of the bottom end 13 from the first side 14 to the second side 15. Alternatively, the top end 12 of the platform 11 may be of a greater or lesser length than the bottom end 13 of the platform 11.

Additionally, in the shown embodiment, the length of the first side 14 from the top end 12 to the bottom end 13 is equal to the length of the second side 15 from the top end 12 to the bottom end 13. Alternatively, the first side 14 may be of a greater or lesser length than the second side 15 of the platform 11. In the illustrated embodiment, the top end 12 and the bottom end 13 are of an identical length lesser than an identical length of the first side 14 and the second side 15. As such, the platform 11 is rectangular in shape, providing a surface area sufficient for providing a readable surface that is connectable to a cable.

The platform 11 comprises an arcuate curvature. The arcuate curvature is configured to enable proper affixation to a round cable. Ideally, the arcuate curvature will be of a sufficient curvature to rest flush against a cable on which the platform 11 is placed. In some embodiments, the platform 11 is constructed of a flexible material, such as to provide flexibility to the arcuate curvature. As such, the platform 11 will be able to bend around the cable to rest flush upon the cable. In one embodiment, the platform 11 is constructed of a plastic material.

A first fastener 16 is disposed on the top end 12 of the platform 11. The first fastener 16 is configured to secure a top portion of the platform 11 to the cable on which the cable line label device is affixed. In the illustrated embodiment, the first fastener 16 is a cable tie, wherein the cable tie lock 17 is disposed on the first side 14 of the platform 11 opposite the cable tie 16 on the second side 14 of the platform 11. As such, the user will be able to control the tightness through which the platform 11 is secured to the cable. In one embodiment, the first fastener 16 is removable from the platform 11.

A second fastener 18 is disposed on the bottom end 13 of the platform 11. The second fastener 18 is configured to secure a bottom portion of the platform 11 to the cable on which the cable line label device is affixed. In the illustrated embodiment, the second fastener 18 is a cable tie, wherein the cable tie lock 19 is disposed on the first side 14 of the platform 11 opposite the cable tie 18 on the second side 14 of the platform 11. As such, the user will be able to control the tightness through which the platform 11 is secured to the cable.

In the illustrated embodiment, the platform only includes the first fastener 16 and the second fastener 18. The first fastener 16 is placed proximal to the top end 12 of the platform 11 and the second fastener 18 is placed proximal to the bottom end 13 of the platform 11, such as to provide enhanced structural securement.

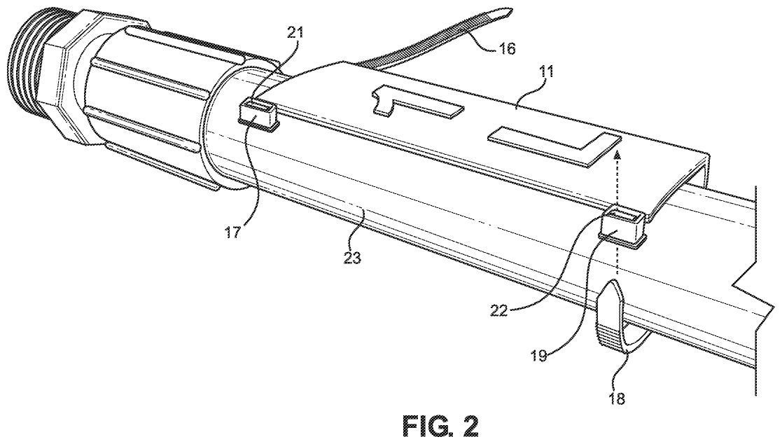

Referring now to FIG. 2, there is shown a perspective view of an embodiment of the cable line label device. In the illustrated embodiment, the first fastener 16 comprises a cable tie 16, a cable tie lock 17 and a cable tie lock tab 21. The cable tie of the first fastener 16 may be inserted into the cable tie lock 17, such that the cable tie lock tab 21 will lock the position of the cable tie of the first fastener 16 therein. The user may engage the cable tie lock tab 21 in order to release the cable tie of the first fastener 16 from the cable tie lock 17. Furthermore, in the illustrated embodiment, the first fastener 16 and the second fastener 18 are identical in structure. As such, in the illustrated embodiment the second fastener 18 comprises a cable tie 18, a cable tie lock 19 and a cable tie lock tab 22. These elements behave functionally as their counterparts of the first fastener 16.

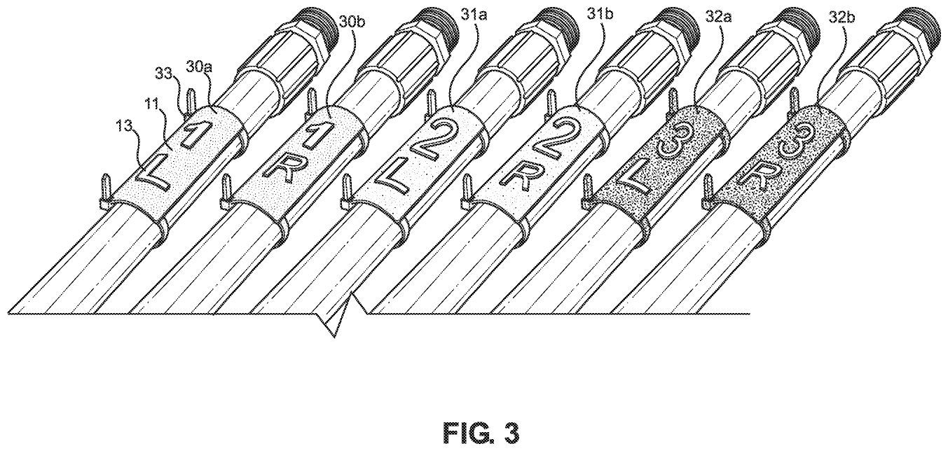

Referring now to FIG. 3, there is shown a demonstrative view of a plurality of cable line label devices. In the illustrated embodiment, a plurality of cable line label devices 30a, 30b, 31a, 31b, 32a, 32b are provided. In some embodiments, the platform of the cable line label device comprises a primary indicia 33 and a secondary indicia 34. The primary indicia 33 and the secondary indicia 34 are configured to provide a visual representation of a feature or characteristic of the cable on which the cable line label device 30a, 30b, 31a, 31b, 32a, 32b is installed. For example, the primary indicia 33 may be an alphabetical indicia and the secondary indicia 34 may be a numerical indicia 34.

In some embodiments, the cable line label device may comprise a platform, a first fastener and a second fastener of a color corresponding to a utility or characteristic associated with the cable line on which the cable line label device is affixed. For example, in the demonstrated embodiment, the first pair of cable line label devices 30a, 3b are of a first color, the second pair of cable line label devices 31a, 31b are of a second color, and the third pair of cable line label devices 32a, 32b are of a third color. As such, the color of the cable line label device may be utilized to designated a characteristic, such as the contents, of the corresponding cable line.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A cable line label device, comprising:
a platform comprising a top end opposite a bottom end;
the platform further comprising a first side opposite a second side;
the platform defining an arcuate curvature from the first side to the second side, such that the platform forms a flush surface with a cable;
a first fastener disposed at the top end of the platform;
a second fastener disposed at the bottom end of the platform;
the first fastener and the second fastener configured to secure the platform to the cable.

2. The cable line label device of claim 1, wherein the first fastener and the second fastener are identical in structure.

3. The cable line label device of claim 1, wherein the first fastener is a cable tie.

4. The cable line label device of claim 1, wherein the second fastener is a cable tie.

5. The cable line label device of claim 1, wherein the platform is composed of a plastic material.

6. The cable line label device of claim 1, wherein the first fastener and the second fastener are removable from the platform.

7. The cable line label device of claim 1, wherein the first side and the second side are of a greater length than the top end and the bottom end.

8. The cable line label device of claim 1, wherein the platform comprises a primary indicia on a top face of the platform.

9. The cable line label device of claim 1, wherein the platform comprises a secondary indicia on a top face of the platform.

10. The cable line label device of claim 1, wherein the platform, first fastener and second fastener are of a color corresponding to a utility associated with the cable.

11. The cable line label device of claim 1, wherein the first fastener and the second fastener are each disposed on the first side of the platform.
